(19) United States
(12) Patent Application Publication
(10) Pub. No.: US 2008/0282573 A1
(43) Pub. Date: Nov. 20, 2008

(54) Tilting microwave dryer and heater

(76) Inventors: William Hein, Sheridan, WY (US); Brian Granger, Sheridan, WY (US)

Correspondence Address: Gene R. Woodle, 3516 Woodle Drive, Rapid City, SD, 57702, US

(21) Appl. No.: 11/803,203

(22) Filed: May 14, 2007

(51) Int. Cl. F26B 3/347

(52) U.S. Cl. 34/265

(57) ABSTRACT

Embodiments of a microwave dryer are disclosed which may be used to dry or heat materials such a sewage sludge. The microwave dryer uses a reciprocating ram to push the material through a loading section and into a treatment section where the material is subjected to microwaves to drive of liquid content. The material is then pushed into an unloading section where it is removed from the microwave dryer. The dryer may be tilted to adjust the rate of flow of material through the dryer. Air nozzles on the bottom of the dryer direct air such that air flow through the nozzles may also be used to adjust the flow rate of material.

### BACKGROUND OF THE INVENTION

1. Field of the Invention

The present invention relates generally to an apparatus for drying or heating material using microwaves and more specifically to a microwave dryer which may be tilted to change the angle at which material moves through the dryer and air flow through the dryer.

2. Background Information

For hundreds of years people have been dealing with problems relating to drying a variety of materials. Perhaps the simplest method of drying is to hang strips of meat or fish above a fire to drive out the water. Rotary kilns and centrifuges have also been used for may years to dry materials.

Relatively recently, microwaves have been used in a variety of ways to dry or heat materials. Several patents have been issued which disclose methods or apparatus for drying. The patent to Gaon et al. (U.S. Pat. No. 5,202,139; Apr. 13, 1993) discloses a process for preparing fat free snack chips. This patent describes a microwave transparent conveyor belt which transports the chips through both high and low intensity microwaves.

The tilting microwave dryer and heater of the instant invention is believed to solve, in a new and unique fashion, many problems relating to drying or removing liquids from any of a variety of materials. The tilting microwave dryer and heater of the instant invention provides for drying at a maximum rate in a continuous process and could be used to dry materials ranging from sewage sludge to coal.

The ideal tilting microwave dryer and heater may be used to remove water or other liquids from a variety of materials in a continuous process.

The ideal tilting microwave dryer and heater must also be capable of processing large amounts of material.

The ideal tilting microwave dryer and heater may easily be adapted to treating various quantities and types of material.

The ideal microwave dryer is also simple, safe, rugged, inexpensive, and easy to use.

These and other features of the invention will become apparent when taken in consideration with the following detailed description and the drawings.

### SUMMARY OF THE INVENTION

The tilting microwave dryer and heater of the instant invention comprises a loading section, a treatment section, and an unloading section. The loading section is considered to be at the upstream end of the dryer and the unloading section is considered to be at the downstream end of the dryer. The dryer of the instant invention is supported by a hinge on its downstream end and by a hydraulic rod at its upstream end such that it may be tilted so that material moves through the loading section, treatment section, and unloading section at an angle.

The loading section includes a hopper on the top of the section into which untreated material may be introduced by a conveyor or other conventional means. The material drops into a channel which has a flat bottom and vertical side walls. A hydraulically operated, reciprocating ram is provided which pushes the material from the loading section into a treatment channel within the treatment section. The treatment channel has the same cross-sectional shape as the loading channel. A plurality of microwave guides which are each covered with a microwave transparent cover open into the interior of the treatment channel. Microwaves are emitted from the guides and heat the material as it passes through the treatment section. Air is introduced into the downstream end of the treatment section above the material. The air passes over the material in the treatment section, picks up the water which is driven from the material by the microwaves, and is extracted from the treatment section near the upstream end of the treatment section. Air is also introduced at the bottom of the treatment section through air nozzles which force the air in a downstream direction through the material. The water may then be removed from the air by a condenser or other conventional means.

The material is then forced by the reciprocating ram from the treatment section into the unloading section. The reciprocating ram also acts as a choke to prevent the microwaves from escaping from the instant invention. The treated material is removed from the bottom, downstream end of the unloading section through a chute.

The loading section channel, treatment section channel, and unloading section channel are affixed to each other and all ride on hydraulic lifts such that the slope of the channels may be adjusted to change the flow rate of the material and separated liquids through the various sections. Sensors are placed at various points along the material stream to monitor the temperature and the amount of water in the channels. In addition, the flow of the material may also be controlled by changing the flow rate of air through the air nozzles. The air flow creates a bed which lessens the friction between the bottom surface of the dryer and the material. That is, increasing the flow rate of air through the nozzles increases the flow of material through the dryer.

The tilting microwave dryer and heater of the instant invention could be easily adapted to dry or heat a wide variety of materials such as sewage sludge, corn, coal, or wood chips. One of the major objects of the present invention is to provide a tilting microwave dryer and heater which may be used to remove water or other liquids from a variety of materials in a continuous process. Another objective of the present invention is to provide a tilting microwave dryer and heater which is capable of processing large amounts of material. Another objective of the present invention is to provide a tilting microwave dryer and heater which may easily be adapted to treating various quantities and types of material.

Another objective of the present invention is to provide a microwave dryer which is simple, safe, rugged, inexpensive, and easy to use.

These and other features of the invention will become apparent when taken in consideration with the following detailed description and the drawings.

### BRIEF DESCRIPTION OF THE DRAWINGS

FIG. 1 is a side view of the tilting microwave dryer and heater of the instant invention;

FIG. 2 is a partial sectional view of the tilting microwave dryer and heater of the instant invention taken along line 2-2 of FIG. 1;

FIG. 3 is a partial sectional view of the tilting microwave dryer and heater of the instant invention taken along line 3-3 of FIG. 2; and

FIG. 4 is free body diagram of an object sliding down a plane.

### DESCRIPTION OF THE PREFERRED EMBODIMENT

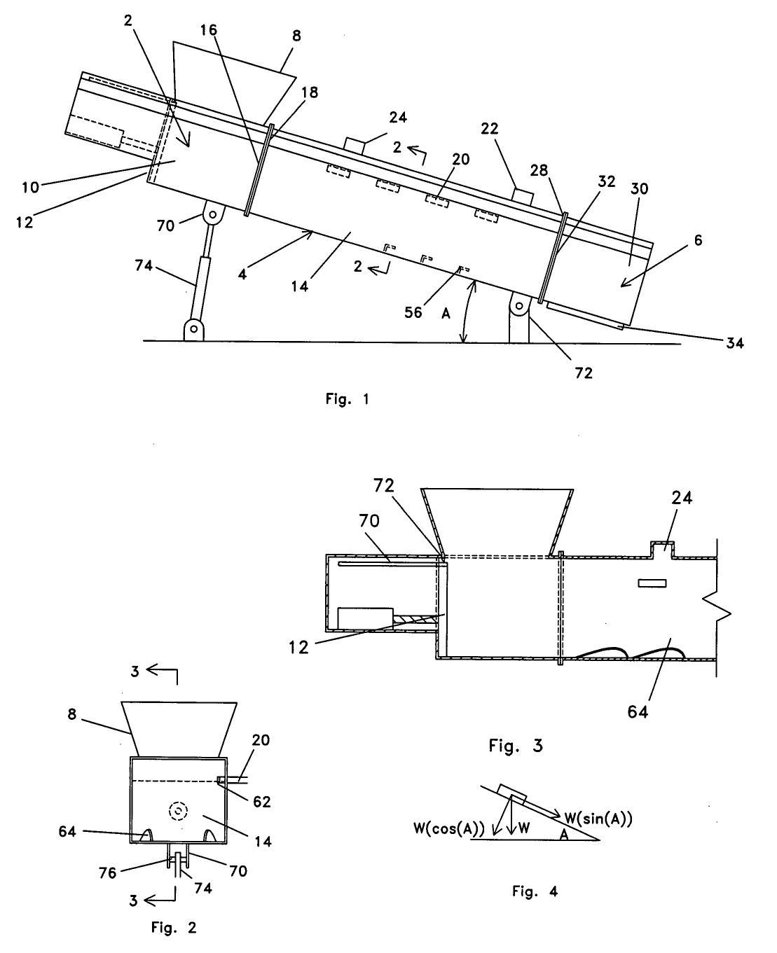

Referring to the drawings, FIGS. 1 through 3, a preferred embodiment of the tilting microwave dryer and heater of the instant invention is shown. The dryer may be used to dry any of a variety of materials including corn, sewage sludge, coal, or wood chips.

Referring now to FIG. 1, the tilting microwave dryer and heater of the instant invention may be divided into a loading section 2, a treatment section 4, and an unloading section 6. The loading section 2 is considered to be at the upstream end of the dryer and the unloading section 6 is considered to be at the downstream end of the dryer. Material may be introduced into said loading section 2 by a conveyor (not shown) or other conventional means through a hopper 8. The material falls through the hopper 8 into a loading channel 10. The loading channel 10 has a flat bottom, two vertical side walls, and a top which is open beneath said hopper 8. A reciprocating ram 12 is provided which has the same shape and size as the interior of said loading channel 10 and fits within said loading channel 10. The reciprocating ram 12 is hydraulic and is capable of pushing the material from beneath said hopper 8 into the treatment section 4.

Still referring to FIG. 1, said treatment section 4 includes a treatment channel 14 which has the same cross-sectional shape as said loading channel 10. Said loading channel 10 includes a loading flange 16 and the loading flange 16 may be bolted to a complimentary treatment flange 18 on the treatment channel 14. A plurality of microwave guides 20 open into the interior of said treatment channel 14 and emit microwaves through the material. This heats the material and acts to drive off the water from the material. Dry air is introduced into the interior of said treatment channel 14 at the downstream end of said treatment channel 14 through a plurality of air intakes 22. The air passes over the material and is removed from the upstream end of said treatment channel 14 through an air outlet 24. Air flow through the air intakes 22 is powered by conventional fans (not shown) and water may be removed from the air by a condenser or other conventional means. Said reciprocating ram 12 also acts as a choke to prevent microwaves from escaping the dryer.

Still referring to FIG. 1, a plurality of air nozzles 56 are affixed to the bottom of said treatment channel 14. The air nozzles 56 are positioned such that they may force air through the bottom portion of the material in said treatment channel 14 in a downstream direction creating an air bed. This air flow acts, in effect, to decrease the friction between the material and the surface of said treatment channel 14 and tends to increase the flow rate of the material through the dryer. Air introduced through said air nozzles 56 is also removed from the dryer by the air outlet 24. Air may also be removed from said treatment section 4 by creating a vacuum at said air outlet 24.

Still referring to FIG. 1, said reciprocating ram 12 further pushes the sludge through said treatment section 4 and into the unloading section 6. Said unloading section 6 includes an unloading channel 30 which also has the same cross-sectional size and shape as said loading channel 10. The unloading channel 30 includes an unloading flange 32 which may be bolted to a second treatment flange 28. The bottom of said unloading channel 30 opens into a chute 34. The material either drops out of the dryer through the chute 34 or is removed by some other conventional means such as an auger.

Still referring to FIG. 1, a flange 70 is affixed to the bottom of said loading section 2 and a hinge 72 is affixed to the bottom of said treatment section 4 just upstream from said second treatment flange 28. The dryer rotates to a limited extent about the hinge 72 such that the angle of said treatment channel 14 and the rest of the dryer may be varied. A hydraulic piston 74 is rotatably affixed to the flange 70 and to the floor such that it may be used to raise or lower the upstream end of the dryer. Although the instant invention is described as having a single hydraulic piston 74, two or more could easily be used.

Referring now to FIG. 2, a partial sectional view of the microwave dryer of the instant invention taken along line 2-2 of FIG. 1 is shown. Said microwave guides 20 open into the interior of said treatment channel 14 and the openings on said microwave guides 20 are covered by microwave transparent coverings 62 to prevent contaminants from entering said microwave guides 20. A plurality of stirring vanes 64 are affixed to the bottom of said treatment channel 14 to stir the sludge as it is pushed through said treatment section 4. The stirring vanes 64 could also be placed on the sides of said treatment channel 14. This view shows that the top of the hydraulic piston 74 is affixed to said flange 70 by a flange pin 76 such that the top of said hydraulic piston 74 can rotate about the flange pin 76.

Referring now to FIG. 3, a cross-sectional view of the microwave dryer of the instant invention taken along line 3-3 of FIG. 2 is shown. This view also shows a cover 70 which is affixed to the top of said reciprocating ram 12 and protrudes upstream from said reciprocating ram 12. The cover 70 acts to close the opening beneath said hopper 8 when said reciprocating ram 12 is in the downstream position and prevents Material from falling into said loading channel 10 upstream of said reciprocating ram 12. A scraper 72 is affixed to the top of said loading channel 10 and protrudes downward from a point beneath the upstream end of said hopper 8. The scraper 72 contacts the top of said cover 70 and scrapes material from the top of said cover 70 when said reciprocating ram 12 is moving in an upstream direction.

A plurality of conventional sensors (not shown) are located within each of the treatment sections and monitor the temperature, humidity, material flow rate, and material level. The water content of the material exiting said chute 34 is also monitored. The microwaves are generated and transmitted to said microwave guides 20 in a conventional manner which uses a conventional magnetron (not shown). The microwave generator, said hydraulic piston 74, the sensors, and said reciprocating ram 12 are all connected to a PLC (programmable logic controller). The PLC controls the cyclic rate of the reciprocating rams, the angle of the dryer, air injection system and the output of the microwave generator. If the temperature at any point within the treatment section gets too high or too low, the PLC adjusts the level of microwaves in the appropriate microwave guide 20 to adjust the temperature. The speed of the movement of the material through the dryer is adjusted by adjusting the cyclic rate of the reciprocating rams and the slope of the channels. The PLC also adjusts the rate of air flow through said air nozzles 56. As is described in more detail below, the air flow rate through said air nozzles 56 may also be used to control the flow rate of material through the dryer. In the configuration described above, the air flow may be regulated from 0 to 7,000 cfm, the microwave generator from 0 to 4,000 kw, and the flow of material from 0 to 4 tons per hour, but, of course, these parameters may be easily adjusted based on material and equipment.

The control system (not shown) is PLC based and will take inputs from a conventional automatic magnetron protection system, user safety securities, and process control systems to evaluate and control all microwave generation and material flow. The automatic magnetron protection system includes a cooling system for the magnetron, and electromagnetic current monitoring system, and filament current monitoring system, an anode current monitoring system, a reflected power monitoring system, and an arc detection circuit. The magnetron is a conventional device used to supply microwaves to said microwave guides 20.

The cooling system includes two flow switches and a thermostat. The first flow switch is located on the discharge side of the primary supply main. The second flow switch is located downstream of the magnetron in the secondary coolant system through the magnetron. The thermostat is located on the downstream side of the magnetron in the secondary coolant system. All of the switches for the cooling system ensure that the magnetron does not get overheated and decrease the life span of the magnetron tube. The monitoring circuit for the electromagnetic current is set to drop out when the current reaches 75% of the lowest optimum operating current. The monitoring circuit also monitors the integrity of the supply, with the most likely fault being total lack of current. The filament current is monitored in the secondary of the EHT insulated filament transformer. It is set to drop out at 75% of the lowest optimum operating current. These elements are supplied by the microwave manufacturer and are not considered part of the invention.

The anode current monitoring system is the most critical in ensuring magnetron longevity and monitors the current flow to the anode, and if it exceeds the absolute maximum, it is set to drop out the EHT anode supply. The energy dissipated in the magnetron under the over-current fault conditions is proportional to the reaction time of the interlock, which is the time taken for the main contactor in the power supply to clear its contactor. Reflected power is diverted and monitored. The power is diverted away from the magnetron into a dummy water load using a three port circulator. The reflected power is also measured, and if it rises above a preset limit, the magnetron is switched off. These elements are supplied by the microwave manufacturer and are not considered part of the invention.

An arc detection system is provided in the interior of the apparatus and monitors the interior and the wave guides for any arcing. If arcing is detected, the microwaves in the area of the arcing will go into a standby mode for five seconds to allow any ionized gases to disperse before reapplying power to those microwaves. In the event that arcing persists, the power which provides microwaves to said microwave guides 20 is cut and said reciprocating rams 12 continue operating which will break up the area in the material where voltage breakdown occurred. The arc detector is conventional, is optical, and uses a photodiode.

A user safety system is also provided which includes two electronic systems. A material system ensures that there is sufficient material within the apparatus to warrant operation. If there is insufficient material, power can not be applied to the magnetron. A microwave detection system includes microwave detectors located near any open apertures. If these detectors detect microwave leakage beyond acceptable levels, power to the magnetron is cut off.

The process control system takes input from the humidity, temperature, and flow rate sensors to control the frequency of said reciprocating ram 12, air movement over the material, angle of the dryer, the air injection nozzles, and the power output from the microwave generators. A plurality of humidity sensors are located along the material stream, at said air intakes 22, and at said air outlets 24. If humidity above acceptable levels is detected, air flow through the apparatus is increased by increasing air flow through said air intakes 22 and said air outlets 24. Air flow through said air nozzles 56 is also controlled and may be varied to reduce humidity and to change the flow rate of the material through the dryer. A plurality of temperature sensors are also located along the material stream. If temperature levels are greater than optimum, power to the microwave generators could be reduced and, if temperature levels are less than optimum, power to the microwave generators could be increased. However, in the preferred embodiment of the instant invention it appears that it would be more efficient to operate the microwave generators at or near maximum power and adjust the other parameters mentioned above, such as the angle of the dryer, to control humidity. Flow rate and material level sensors are located at the upstream end of said treatment section 4. If these sensors detect too little material within said treatment section 4, the frequency of operation of said reciprocating ram 12 will be increased. The flow of material into said hopper 8 would also have to be increased. If these sensors detect too much material within said treatment section 4, the frequency of operation of said reciprocating ram 12 will be decreased or the feed rate into said hopper 8 decreased.

Furthermore, said hydraulic piston 74 is also controlled by the control system. In the event that material is flowing too rapidly through the dryer, said hydraulic piston 74 may be activated to lower the upstream end of said treatment section 4. In the event that material is flowing to slowly through the dryer, said hydraulic piston 74 may be activated to raise the upstream end of said treatment section 4.

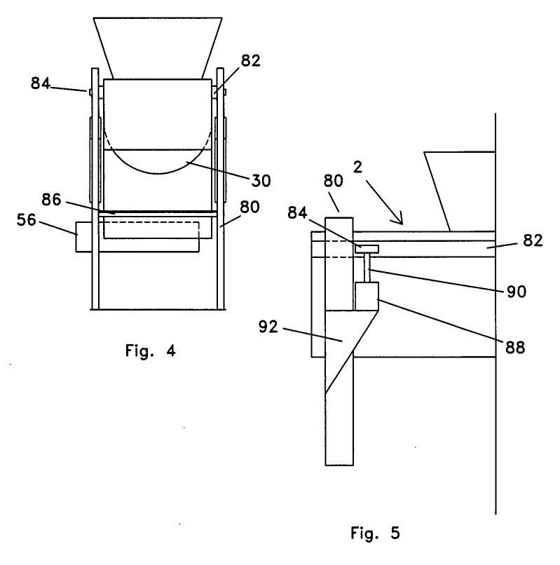

As may be seen from the above, a number of factors must be considered in determining how quickly the material should pass through the tilting microwave dryer and heater of the instant invention. By changing the angle A (see FIG. 1) which is the slope of the dryer, the speed of the material flowing through the dryer may be controlled. There are two forces which must be considered when determining the force necessary to push material through the dryer: the sliding force (Fs) and the “bunching” force (Fb). Fs is the amount of force necessary to move the material smoothly through the dryer with as much material leaving the dryer as entering the dryer. Fb is greater than Fs and results in the material bunching or piling up such that more material is entering the dryer than is leaving the dryer. Fb may be determined experimentally by determining the amount of force applied to push the particular material such that the material does not move smoothly, but compacts or bunches up. Fs is equal to U times Na where U is the static coefficient of friction and Na is the normal force. Na equals W times cos(A) where W is the force of gravity and A is the angle A. By simple geometry, Fs also equals W times sin(A) (see FIG. 6). Therefore, W times sin(A) equals U times W times cos(A) and U equals tan(A). U can be determined for any material by placing the material on a surface the same as the surface of the dryer sections and tilting the surface until the material begins to slide. The tangent of the angle at which the material begins to slide is U. See FIG. 4.

As an example, assume that Fb for a particular material is 100 lb. Because we want the material to slide rather than to bunch up, Fb>Fs and 100 lb.>Fs. Experimentally, the value of U is for the material is found to be 0.45. Further assume that there is 450 lb. of material in the dryer and the angle A is 15.5 degrees. Na equals (450)(cos(15.5)) equals 433.63 lb. Since Fs equals U times Na, Fs equals (0.45)(433.63 lb.) equals 195.14 lb. In this case, Fs is greater than Fb and the material will bunch up rather than slide through the dryer.

In the above example, the 450 lb. load and 15.5 degree angle may be optimal for drying, but this configuration will not work because Fs>Fb. However, referring again FIG. 1, said air intakes 22 are configured such that they force air downstream along the bottom surface of the material. This has the effect of lowering U for the material. In many cases the flow of air through said air nozzles 56 may be controlled such the U is lowered sufficiently for Fs<Fb. Therefore, by adjusting the air flow through said air nozzles 56 the tilting microwave dryer and heater of the instant invention may be operated at optimal conditions where this would not be possible without the addition of said air nozzles 56 in the configuration described.

In the preferred embodiment of the tilting microwave dryer and heater of the instant invention, unless otherwise specified; all elements are made from steel, but other materials having similar strength, pliability, and weather resistance could be used. All materials or elements which come into contact with corrosive materials are coated to prevent corrosion. The various channels are made from aluminum; but other materials having the same strength, weight characteristics, and corrosion resistance could be used. The interior of the various channels are lined on the inside surfaces to decrease wear, resist degradation from high temperatures, and provide a low friction coefficient. Various materials including polyetherimides could be used.

A number of companies specializing in manufacturing microwave generators can manufacture the above described microwave generators including all described controls and sensors. Such companies include Richarson Electronics, Woodland Hills, Calif.; Ferrite, Hudson, NH; and California Tube Laboratory, Inc.; Watsonville, Calif.

While preferred embodiments of this invention have been shown and described above, it will be apparent to those skilled in the art that various modifications may be made in these embodiments without departing from the spirit of the present invention.

We claim:

1. A tilting microwave dryer and heater for drying or heating various materials, the tilting microwave dryer having a treatment section in which the materials are subjected to microwaves, and the materials being introduced at the upstream end of the tilting microwave dryer and heater and leaving the tilting microwave dryer and heater at the downstream end, comprising:
(1) means for tilting the treatment section such that the angle of the treatment section may be adjusted and the flow rate of material through the treatment section controlled by the size of the angle;
(2) a plurality of nozzles located on the bed of the treatment section such that a gas may be forced through the nozzles in the downstream direction; and
(3) means for controlling the amount of flow of the gas through said nozzles such that the flow of material through the tilting microwave dryer and heater by also be controlled by the flow rate of the gas through said nozzles;
whereby material may be heated within the tilting microwave dryer and heater and the flow rate of material through the treatment section of the tilting microwave dryer and heater may be controlled by controlling the angle of the treatment section and the flow rate of gas through said nozzles.

2. The microwave dryer of claim 1 in which the gas flows through said nozzles in the upstream direction.

3. A tilting microwave dryer and heater for drying or heating various materials, the tilting microwave dryer having a treatment section in which the materials are subjected to microwaves, and the materials being introduced at the upstream end of the tilting microwave dryer and heater and leaving the tilting microwave dryer and heater at the downstream end, comprising:
(1) a hinge at the downstream end of the microwave dryer and heater such that the microwave dryer and heater rotate about the hinge in the plane of the microwave dryer and heater;
(2) a plurality of hydraulic pistons affixed at the upstream end of the tilting microwave dryer and heater such that the hydraulic pistons may controlled to raise or lower the upstream end of the microwave dryer and heater.
(3) a plurality of nozzles located on the bed of the treatment section such that a gas may be forced through the nozzles in the downstream direction; and
(4) means for controlling the amount of flow of the gas through said nozzles such that the flow of material through the tilting microwave dryer and heater by also be controlled by the flow rate of the gas through said nozzles;
whereby material may be heated within the tilting microwave dryer and heater and the flow rate of material through the treatment section of the tilting microwave dryer and heater may be controlled by controlling the angle of the treatment section and the flow rate of gas through said nozzles.

4. The microwave dryer of claim 3 in which the gas flows through said nozzles in the upstream direction.

5. The microwave dryer of claim 1 in which gas is extracted from the upstream end of the treatment section.

6. The microwave dryer of claim 2 in which gas is extracted from the upstream end of the treatment section.

7. The microwave dryer of claim 3 in which gas is extracted from the upstream end of the treatment section.

8. The microwave dryer of claim 4 in which gas is extracted from the upstream end of the treatment section.
